(19) United States
(12) Patent Application Publication
(10) Pub. No.: US 2003/0145831 A1
(43) Pub. Date: Aug. 7, 2003

(54) Fuel injection unit

(76) Inventor: Uwe Liskow, Pleidelsheim (DE)

Correspondence Address: KENYON & KENYON, ONE BROADWAY, NEW YORK, NY, 10004, US

(21) Appl. No.: 10/169,967

(22) PCT Filed: Nov. 12, 2001
(86) PCT No.: PCT/DE01/04206

(30) Foreign Application Priority Data
Nov. 11, 2000 (DE) 100 56 005.9

(51) Int. Cl. F02M 1/00

(52) U.S. Cl. 123/470

(57) ABSTRACT

A fuel injection system including at least one fuel injector having an inlet section and a fuel distributor line with a connecting piece for each fuel injector. For sealing a connection of each fuel injector to the respective connecting piece of the fuel distributor line, a ring-shaped seal support is provided for each, having an inner sleeve which is guided by a guide section of the inlet section, and having an outer sleeve which radially surrounds the inner sleeve and is elastically connected to the inner sleeve radially. The seal support together with the outer sleeve surrounds a sealing element. At the same time, the sealing element is peripherally in contact with an inside wall of the connecting piece and axially in contact with a radial end face of the inlet section of the fuel injector.

### BACKGROUND INFORMATION

The present invention relates to a fuel injection system for injection of fuel into an internal combustion engine, in particular for direct injection of fuel into the combustion chamber(s) of the internal combustion engine.

The present invention relates to a fuel injection system according to the preamble of the main claim. Such a fuel injection system is known from German Patent Application 197 25 076 A1. It has a ring-shaped seal support for a sealing connection between a fuel injector and a respective connecting piece of a fuel distributor line, this seal support cooperating with a first sealing element for sealing the seal support with respect to an end face of an inlet section of the fuel injector and cooperating with a second sealing element for sealing the seal support with respect to the connecting piece of the fuel distributor line. A bushing insertable into a fuel inlet orifice of the inlet section passes through the ring-shaped seal support, so that the seal support is movably secured in the radial direction between an upstream collar of the bushing and the inlet section of the fuel injector.

One disadvantage of the arrangement described in the aforementioned publication is that due to the total of two sealing elements, there are two components which may be subject to defects and may result in leakage in particular. The two sealing elements are installed one above the other and therefore require vertical space. Since the sealing elements may not lie in direct contact with one another and sufficient material must be available to fill out the ring grooves, the additional vertical space required for the seal support is not insignificant. Another disadvantage of the arrangement described in the aforementioned publication is that radial mobility of the seal support is guaranteed only if it has a certain axial play and is not pressed by the bushing against the inlet section. Consequently, during installation the bushing must be inserted into the fuel inlet orifice to a precisely defined depth and the bushing as well as the fuel inlet orifice in the fuel injector must be manufactured to a very high precision.

A fuel injector which has an inlet section and is insertable into a receiving bore and is sealed by an O-ring on this inlet section with respect to a connecting piece of a fuel distributor line is already known from Unexamined Japanese Patent 08-312503. The O-ring is in sealing contact with an inside wall of the connecting piece.

One disadvantage of this known related art is that the deviations which occur in the fuel injector relative to the fuel distributor line due to manufacturing tolerances may be compensated only by asymmetrical pinching of the O-ring inasmuch as the axes of the connecting piece of the fuel distributor line and the fuel injector are shifted relative to one another. This results in leakage even with relatively minor pinching of the O-ring.

### ADVANTAGES OF THE INVENTION

The fuel injection system according to the present invention having the characterizing features of the main claim has the advantage over the related art that deviations in the axial position of the connecting piece of the fuel distributor line and the fuel injector relative to one another are compensated reliably. This prevents unwanted warping of the fuel injector relative to the fuel distributor line. This yields in particular a smaller vertical space required in comparison with the known seals, which allows tolerances to be compensated.

Advantageous refinements of and improvements on the fuel injection system characterized in the main claim are possible through the features characterized in the subclaims.

In an advantageous embodiment, the inner sleeve and the outer sleeve are connected by spiral springs.

It is particularly advantageous to provide pressure equalizing bores in the outer sleeve to connect the fuel chamber to a clearance volume formed between the sealing edges of the sealing means and the outer sleeve. The sealing means is thus acted upon by the pressure of the fuel over a larger extent of its cross section and the contact pressure of the sealing edges is increased.

The seal support is advantageously secured by a locking ring on the guide section of the fuel injector with its inner sleeve against the end face of the inlet section. It is also advantageous that a gap remains between the end face of the inlet section and the outer sleeve of the seal support due to the elasticity of the sealing element even when acted upon by fuel under pressure. Even when the inner sleeve is pressed by the locking ring against the end face due to the manufacturing tolerances, the outer ring having the sealing element retains its functionality.

In an advantageous embodiment, the guide section is formed by a hollow screw which is screwed into a threaded bore of the fuel injector and holds the seal support against the fuel injector.

The outer ring advantageously has an upstream peripheral conical chamfer situated on the outside radially. This facilitates insertion of the seal support into the connecting piece.

### DRAWING

Exemplary embodiments of the present invention are illustrated in simplified form in the drawing and explained in greater detail in the following description.

FIG. 1 shows a section through an exemplary embodiment according to the present invention in a detail of an illustration of the connecting area between the fuel injector and the fuel distributor line;

FIG. 2 shows a top view of a seal support of the exemplary embodiment illustrated in FIG. 1;

FIG. 3 shows a top view of an alternative embodiment of a seal support; and

FIG. 4 shows another embodiment of a fuel injection system according to the present invention in a detail corresponding to detail IV in FIG. 1.

### DESCRIPTION OF THE EXEMPLARY EMBODIMENTS

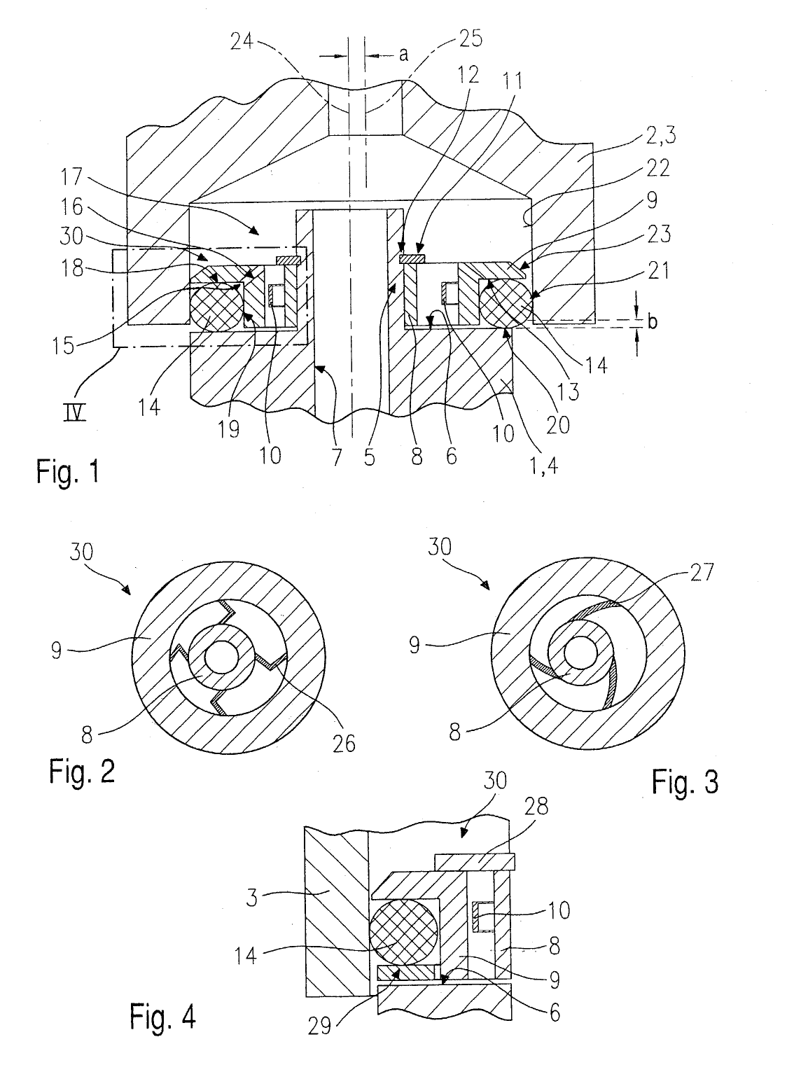

FIG. 1 shows, as a sectional diagram of a portion of an exemplary embodiment according to the present invention of a fuel injection system, the connecting area between a fuel injector 1 and a fuel distributor line 2. Fuel distributor line 2 is shown here only in the area of a connecting piece 3, and fuel injector 1 is shown here only in the area of an inlet section 4 having a guide section 5.

Inlet section 4 is formed in one piece with fuel injector 1. An end face 6 is formed at the transition of inlet section 4 to guide section 5. A fuel inlet bore 7 of fuel injector 1 passes through guide section 5 and inlet section 4. A seal support 30 is composed of an inner sleeve 8 and an outer sleeve 9 which surrounds inner sleeve 8 radially and is elastically connected to inner sleeve 8 via plate springs 10 arranged in a spiral. Guide section 5 passes through and guides inner sleeve 8. A locking ring 11 secures inner sleeve 8 in its position and presses it against end face 6 of inlet section 4.

Locking ring 11 is inserted into a peripheral groove 12 of guide section 5. An O-ring 14 is inserted as a sealing element into a rectangular step 13 which is formed on outer sleeve 9 and faces end face 6. A clearance volume 15 between outer sleeve 9 and O-ring 14 communicates with fuel chamber 17 to be sealed via a pressure equalizing bore 16. Clearance volume 15 is formed between sealing edges 18, 19 of O-ring 14 with respect to step 13 of outer sleeve 9. With an axial sealing edge 20, O-ring 14 rests on end face 6 and with a peripheral sealing edge 21 it rests on an inside wall 22 of connecting piece 3. Outer sleeve 9 has a peripheral conical chamfer 23 on its downstream end. A central axis 24 through fuel injector 1 is shown for the sake of illustration. Likewise, a central axis 25 through connecting piece 3 is also shown. Axes 24, 25 may also have an offset by distance a due to manufacturing tolerances.

Outer sleeve 9 is connected to inner sleeve 8 only elastically by plate springs 10, so that only minor forces are transmitted in the axial direction. Regardless of whether and with what force inner sleeve 8 is pressed against end face 6, a gap b is formed between outer sleeve 9 and end face 6, the size of this gap depending on the elasticity of O-ring 14 and the prevailing pressure in fuel chamber 17. Therefore, outer sleeve 9 is easily displaceable radially. In conjunction with chamfer 23, outer sleeve 9 is adjusted to offset a in assembly. This is possible as long as axial sealing edge 20 is still resting completely on end face 6. In operation of fuel injector 1, the sealing effect of O-ring 14 is reinforced by pressure equalizing bore 16. Due to pressure equalizing bore 16, O-ring 14 is also acted upon by fuel under pressure in clearance volume 15 on its cross-sectional extent between sealing edges 18, 19 against outer sleeve 9. Therefore, the contact pressure on axial sealing edge 20 and peripheral sealing edge 21 is reinforced.

FIG. 2 shows a top view of seal support 30 from FIG. 1 having a design of plate springs 26 according to the present invention. Outer sleeve 9 concentrically surrounds inner sleeve 8. The two are connected elastically via plate springs 26, which are directed radially outward and have a fold in the embodiment illustrated here.

FIG. 3 shows a view of seal support 30 from FIG. 1, illustrating another design of plate springs 27 according to the present invention. Outer sleeve 9 concentrically surrounds inner sleeve 8. The two are connected by plate springs 27, which are designed as spiral plate springs directed radially outward.

FIG. 4 shows another embodiment of a fuel injection system according to the present invention in a detail corresponding to detail IV in FIG. 1. Since this embodiment differs from the embodiment illustrated in FIG. 1 only in this detail, the same reference numbers have been used for the same parts. Seal support 30 is composed of inner sleeve 8 and outer sleeve 9, which surrounds inner sleeve 8 radially and is elastically connected to inner sleeve 8 via plate springs 10 arranged in a spiral. A locking ring 28 sitting in groove 12 holds inner sleeve 8 and outer sleeve 9 against end face 6. O-ring 14 situated in step 13 of outer sleeve 9 is supported by a supporting ring 29 situated between O-ring 14 and end face 6. O-ring 14 is in sealing contact with connecting piece 3.

In the embodiment of fuel injection system illustrated here, outer sleeve 9 is held more securely in its position. O-ring 14 may be deformed to a greater extent by supporting ring 29 without resulting in any leakage.

What is claimed is:

1. A fuel injection system for injecting fuel into an internal combustion engine, having at least one fuel injector (1) which includes an inlet section (4), and having a fuel distributor line (2) which has a connecting piece (3) connectable to the inlet section (4) for each fuel injector (1), wherein to sealingly connect each fuel injector (1) to the respective connecting piece (3) of the fuel distributor line (2), a ring-shaped seal support (30) is provided in each case, which has an inner sleeve (8) guided by a guide section (5) of the inlet section (4), and an outer sleeve (9) surrounding the inner sleeve (8) radially and elastically connected to the inner sleeve (8) radially; and the seal support (30), together with outer sleeve (9), surrounds a sealing element (14), and, at the same time, it holds the sealing element (14) peripherally against an inside wall (22) of the connecting piece (3) and axially against a radial end face (6) of the inlet section (4) of the fuel injector (1).

2. The fuel injection system according to claim 1, wherein the sealing element (14) is guided in a step (13) of the outer sleeve (9) facing the fuel injector (1).

3. The fuel injection system according to claim 1 or 2, wherein the inner sleeve (8) and outer sleeve (9) are elastically connected by springs.

4. The fuel injection system according to claim 3, wherein the springs are plate springs (10, 26, 27) arranged in a spiral between the inner sleeve (8) and the outer sleeve (9).

5. The fuel injection system according to claim 4, wherein the plate springs (26) are folded.

6. The fuel injection system according to one of claims 1 through 5, wherein the outer sleeve (9) has at least one pressure equalizing bore (16) connecting a fuel chamber (17) to be sealed to a clearance volume (15) formed between sealing edges (18, 19) of the sealing element (14) and the outer sleeve (9).

7. The fuel injection system according to one of claims 1 through 6, wherein the inner sleeve (8) of the seal support (30) is secured against the end face (6) of the inlet section (4) by a locking ring (11, 28) at the guide section (5) of the fuel injector (1).

8. The fuel injection system according to claim 7, wherein the locking ring (28) covers the outer sleeve (9) at least partially.

9. The fuel injection system according to claim 8, wherein the locking ring (28) has pressure equalizing bores or grooves through which a fuel chamber (17) to be sealed is connected to pressure equalizing bores (16) in the outer sleeve (9), which are connected to a clearance volume (15) formed between the sealing edges (18, 19) of the sealing element (14) and the outer sleeve (9).

10. The fuel injection system according to one of claims 7 through 9, wherein the locking ring (11, 28) is welded to the guide section (5).

11. The fuel injection system according to one of claims 7 through 9, wherein the locking ring (11, 28) is held in a groove (12) on the guide section (5).

12. The fuel injection system according to one of claims 7 through 9, wherein the locking ring (11, 28) is held on the guide section (5) by a hollow screw which engages in a fuel inlet bore (7) designed as a threaded bore.

13. The fuel injection system according to one of claims 7 through 9, wherein a gap (b) remains between the end face (6) of the inlet section (4) and the outer sleeve (9) of the seal support (30) due to the elasticity of the sealing element (14), even when acted upon by fuel under pressure.

14. The fuel injection system according to one of claims 1 through 13, wherein the sealing element (14) is designed as a peripheral ring seal.

15. The fuel injection system according to one of claims 1 through 14, wherein the outer sleeve (9) has a peripheral conical chamfer (23) situated on the outside, radially at its upstream end.

16. The fuel injection system according to one of claims 1 through 15, wherein a supporting ring (29) is situated between the sealing element (14) and the end face (6) of the inlet section (4).
